(19) United States
(12) Patent Application Publication
(10) Pub. No.: US 2015/0095946 A1
(43) Pub. Date: Apr. 2, 2015

(54) DISPLAY DEVICE AND SERVER DEVICE FOR PROVIDING SERVICE TO EVENT WINNER, AND METHODS THEREOF

(71) Applicant: SAMSUNG ELECTRONICS CO., LTD., Suwon-si (KR)

(72) Inventors: In-ji KIM, Uijeongbu-si (KR); Ho-june YOO, Seoul (KR); Sang-on CHOI, Suwon-si (KR)

(73) Assignee: SAMSUNG ELECTRONICS CO., LTD., Suwon-si (KR)

(21) Appl. No.: 14/448,323

(22) Filed: Jul. 31, 2014

(30) Foreign Application Priority Data
Sep. 27, 2013 (KR) 10-2013-0115507

(51) Int. Cl. H04N 21/458

(52) U.S. Cl. CPC H04N 21/458
USPC 725/34

(57) ABSTRACT

A method for providing a service of a server device is provided. The method includes selecting an event winner from among a plurality of users registered in the server device, storing a multimedia content which is exclusively generated for the event winner, and transmitting the multimedia content to a display device which the event winner uses in response to a predetermined event occurring.

### CROSS-REFERENCE TO RELATED APPLICATION(S)

This application claims priority from Korean Patent Application No. 10-2013-0115507 filed on Sep. 27, 2013 in the Korean Intellectual Property Office, the disclosure of which is incorporated herein by reference in its entirety.

### BACKGROUND

1. Field

Aspects of the exemplary embodiments relate to a display device and a method of providing a service. In particular, exemplary embodiments relate to a display device which determines an event winner based on user information and provides a service, a server device, and a method for providing a service thereof.

2. Description of the Related Art

In the related art, various types of electronic apparatuses have been developed and distributed. A representative example of the related art apparatuses is a display device such as a TV, a mobile phone, and a tablet PC.

In the related art, such a display device could only provide a function of outputting a content and making a user watch the content. However, there have been increasing effort to provide various services through a user interaction.

However, most of the services are provided using a user command. Thus, the user can expect these services as a result of the user command. As a consequence, user satisfaction on service quality is not that high. Accordingly, there has been a necessity to develop technologies that can further improve user satisfaction.

### SUMMARY

An aspect of the exemplary embodiments is designed in accordance with the above-described necessities and is purposed to provide a display device, a server device, and a method for providing a service.

According to an aspect of an exemplary embodiment, there is provided a method for providing a service of a server device includes selecting an event winner from a plurality of users registered in the server device; storing a multimedia content which is exclusively generated for the event winner; and transmitting the multimedia content to a display device which the event winner uses in response to a predetermined event occurring.

The method may further include receiving and registering user information from at least one display device connected to the server device, wherein the event winner is selected based on the user information.

Selecting the event winner may include randomly drawing a user who has a birthday or an anniversary from the users registered in the server device and selecting the user as the event winner.

Selecting the event winner may include calculating a point according to a use state of the users registered in the server device; and selecting the event winner based on the calculated point.

The use state may include at least one of a usage history of a display device, a usage history of a service provided by the server device, usage history of a social network service (SNS) which uses the display device, and a plurality of log-in numbers on the service device.

The multimedia content may include at least one of a visual message which includes a photo of the event winner, a video message which calls a name of the event winner, a voice message, and a text.

A method for providing a service of a display device according to an exemplary embodiment includes transmitting and registering user information to a server device, receiving a multimedia content from the server device; and reproducing and outputting the multimedia content, wherein the multimedia content is a content which is exclusively generated for the user of the display device.

The method may further include transmitting the multimedia content to at least one other display device in response to a sharing command being input on the multimedia content.

The multimedia content may include at least one of a visual message which includes a photo of the user, a video message which calls a name of the user, a voice message, and a text.

According to an aspect of an exemplary embodiment, there is provided a server device including a communicator which is configured to receive user information from a display device; a storage which is configured to store the user information; and a controller configured to transmit a multimedia content which is exclusively generated for an event winner to a display device which the event winner uses in response to the event winner being selected using the user information stored in the storage.

The controller may extract information on a birthday or an anniversary from the user information stored in the storage, randomly draw a user who has the birthday or the anniversary on a current date, and select the user as the event winner.

The controller may calculate a point according to a use state of a plurality of users whose corresponding user information is stored, and select the event winner based on the calculated point.

The use state may include at least one of a usage history of a display device, a usage history of a service provided by the server device, a usage history of a social network service (SNS) which uses the display device, and a plurality of log-in numbers on the service device.

The multimedia content may include at least one of a visual message which includes a photo of the event winner, a video message which calls a name of the event winner, a voice message, and a text.

According to an aspect of an exemplary embodiment, there is provided a display device including a communicator which is configured to perform communication with a server device, an inputter which is configured to receive user information, a controller which is configured to transmit the user information to the server device through the communicator and perform user registration, a content processor configured to reproduce the multimedia content in response to a multimedia content being transmitted from the server device, and an outputter which is configured to output the reproduced multimedia content.

The controller may be further configured to transmit the multimedia content to at least one another terminal device and share the multimedia content in response to a sharing command being input on the multimedia content.

The controller may notify information of a user log-in to the server device in response to the user log-in being performed on the display device.

The device may further include a photographing device configured to perform photographing, wherein the controller is configured to detect a user included in an image photographed by the photographing device and notify a result of the detection to the server device.

The multimedia content may include at least one of a visual message including the user photo, a video message calling a user name, a voice message, and a text.

According to an aspect of another exemplary embodiment, there is provided a method of providing a service of a server device to a plurality of display devices, the method including receiving an event application from a first display device of the display devices; selecting an event winner from a plurality of registered users in the server device in response to the event application being received; storing a multimedia content which is exclusively generated for the event winner; transmitting the multimedia content to a second display device of the display devices; and notifying the first display device of the event winner.

According to the above-described various exemplary embodiments, a display device and a server device may provide a user with an exclusive service. Consequently, satisfaction of a user can be improved significantly.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a view illustrating the configuration of a service providing system according to an exemplary embodiment,

FIG. 2 is a timing diagram to explain a method for providing a service according to an exemplary embodiment,

FIG. 3 is a block diagram illustrating the configuration of a server device according to an exemplary embodiment,

FIG. 4 is a flow chart to explain a method for providing a service of a server device according to an exemplary embodiment,

FIGS. 5-6 are flow charts to explain various examples of a method for selecting an event winner,

FIG. 7 is a view illustrating an example of the detailed configuration of a storage of a server device,

FIG. 8 is a block diagram illustrating the configuration of a display device according to an exemplary embodiment,

FIG. 9 is a flow chart to explain a method for providing a service of a display device according to an exemplary embodiment,

FIG. 10 is a view to explain an example of a user registration process,

FIGS. 11-14 are views to explain various examples of a multimedia content and a method for displaying,

FIG. 15 is a block diagram illustrating the configuration of a display device according to another exemplary embodiment,

FIG. 16 is a view to explain a method for storing a multimedia content,

FIGS. 17-18 are views to explain various methods to share a multimedia content with others,

FIG. 19 is a flow chart to explain a method for providing a service of a display device according to another exemplary embodiment, and

FIG. 20 is a timing diagram to explain the operations of a service providing system according to a still another exemplary embodiment.

### DETAILED DESCRIPTION OF THE EXEMPLARY EMBODIMENTS

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

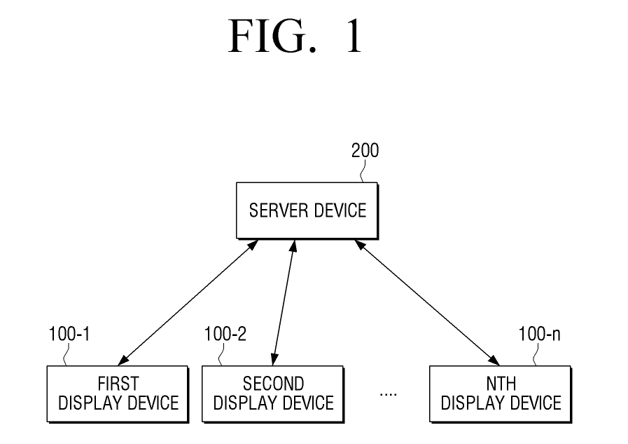

FIG. 1 is a view illustrating the configuration of a service providing system according to an exemplary embodiment. According to FIG. 1, a system includes a server device 200 and a plurality of display devices 100-1 through 100-n. A plurality of display devices are divided into 1st to nth display devices, but each display device can be a device which is independent from each other. In particular, the display device 100-1 through 100-n can be a user terminal device in various types, such as a TV, a mobile phone, a tablet PC, a PC, a lab top PC, an e-frame, a kiosk, an MP3 player, a PDA, etc.

The server device 200 can be embodied as a server device which is operated by a business provider who manufactures or sells the plurality of display devices 100-1 through 100-n, but the server device 200 is not limited to this embodiment. For example, the server device can be embodied as various types of server devices such as a server device operated by an operator who has a separate contract with the business provider, a server device operated by a content creator, a general web server device, a server of a broadcasting station, etc.

In the server device 200, information on each display device 100-1 through 100-n or information on a user who uses the display device can be registered. For example, a user can access the server device 200 through the user display device 100-1 through 100-n, and check a website provided by the server device 200. On a website, a user can input various information related to the user, i.e., user information on a website. The display device 100-1 through 100-n can transmit the input user information to the server device 200 and register the information.

The server device 200 selects an event winner among registered users. The event means an event to, in case of a user nearing anniversary, deliver a multimedia content which contains a congratulatory, an encouraging, or a consolatory message to the user. An anniversary means a date which is meaningful to a user. In particular, an anniversary can include not only days that are exclusively commemorative to each user such as a birthday, a wedding anniversary, a display device purchasing date, a date of joining a company, a date of promotion, a date of childbirth, but also days that are commonly meaningful to many users such as a holiday, Christmas, a national holiday, an election day, a public holiday, etc. Therefore various types of days are named as an anniversary.

An event winner means a user who is named as a person who will be benefitted from the corresponding event. The event winner can be selected by various methods. A method for selecting an event winner will be described later.

The server device 200, when an event winner is selected, prepares a multimedia content which is exclusively created for the event winner. Such multimedia content may include a visual message, a video message, a voice message, and a text, etc. In a multimedia content, a user personal information (name, nickname, photo, etc.) can be included. For example, the multimedia content can be embodied as a video content which films a scene in which celebrities such as entertainers, sports stars, politicians call an event winner and deliver a message suitable for the characteristics of each anniversary. In addition, a multimedia content can be created in various types and methods. Types and a method for generating a multimedia content will be described later.

The server device 200, when an event happens, can transmit the prepared multimedia content to the display device which the event winner uses. For example, when a birthday of the event winner nears, a multimedia content on the corresponding date can be transmitted to the display device. The display device outputs a multimedia content. Accordingly, a user (i.e., the event winner), can receive an unexpected congratulatory message. Thus, the user can be highly satisfied.

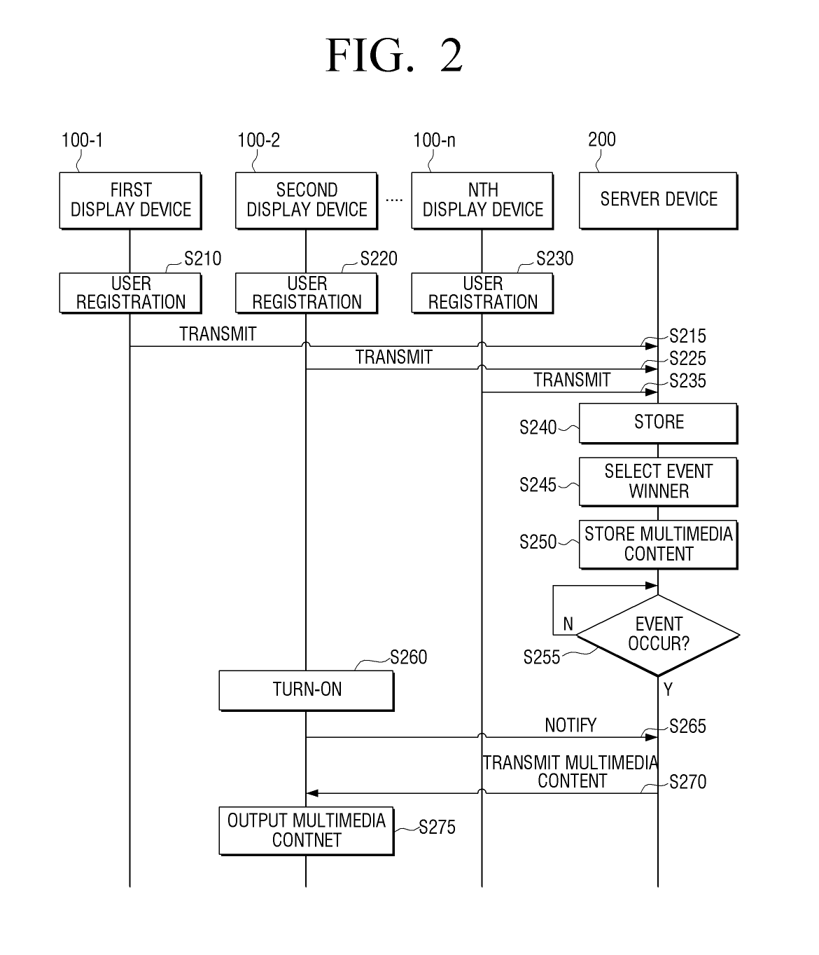

FIG. 2 is a timing diagram to explain a method for providing a service according to an exemplary embodiment. According to FIG. 2, users of a plurality of the display devices 100-1 through 100-n can input user information through the display devices 100-1 through 100-n, and perform user registration S210, S220, S230. User information input in each display device 100-1 through 100-n is transmitted to the respective server device 200 (e.g., S215, S225, S235).

The server device 200 stores each user information which is transmitted and registers a user (S240). User information can have various personal information such as a user name, a birth date, an e-mail address, ID, a password, a photo, a hobby, a specialty, a job, an anniversary, a religion, a preferred content, a preferred channel, etc.

The server device 200, among users registered in a periodic cycle or at a specific point of time, selects the event winner (S245).

When the event winner is selected (S245), the server device 200 stores a multimedia content on the event winner (S250). Multimedia content means a content exclusively generated on the event winner. For example, and as described above, various content can be included, such as a video content in which a celebrity calls a name of an event winner and delivers a congratulatory message to the event winner, a photo content in which a name of an event winner and a congratulatory message are overlaid as a text, a text content in which a name of an event winner and a congratulatory message are provided as a subtitle, etc.

The server device 200 can provide information on an event winner as a content providing source, and ask to create a multimedia content which is exclusive to the event winner. When the corresponding multimedia content is created from the content providing source and is transmitted to the server device 200, the server device 200 can receive and store the multimedia content (S250). Alternatively, the server device 200 can composite a name of an event winner and a congratulatory with various photos and video contents and create/store the multimedia content.

When an event happens in this state (S255), the server device 200 can transmit a multimedia content to the display device which the event winner uses. Herein, the event can be an event in which the anniversary which the event winner registered nears. The server device 200, when the current date is the same as the anniversary registered by the event winner, can determined that an event happens.

FIG. 2 illustrates when a user of the second display device 100-2 is an event winner. In an example of FIG. 2, if the second display device 100-2 is turned off and is turned on for the first time on the event date (S260), the second display device 100-2 can connect communication with the server device 200 and notify that it is turned on (S265).

The server device 200, when it is notified that the second device is turned on, transmits a multimedia content (S270). Accordingly, in the second display device 100-2, a multimedia content can be output (S275).

In FIG. 2, it has been explained that if the second display device 100-2 is turned on, a multimedia content is provided. However, if the display device is a TV, one display device can be used by several users. Therefore, according to still another exemplary embodiment, the second display device 100-2 can recognize whether or not a user having an anniversary, from among several users, is watching, and can notify the server device 200 of the recognition result. The server device 200, only when it is recognized that the event winner is watching, can transmit a multimedia content. This exemplary embodiment will be further explained later.

According to various exemplary embodiments, the server device 200 can transmit a multimedia content to the second display device 100-2 by a streaming method, or may provide the multimedia content to the second display device 100-2 by a downloading method. In addition, a multimedia content can be stored in the second display device 100-2, and be reproduced whenever a user wants. In a case when a user wants the multimedia content, it can be shared with other users. These various exemplary embodiments will be further described later.

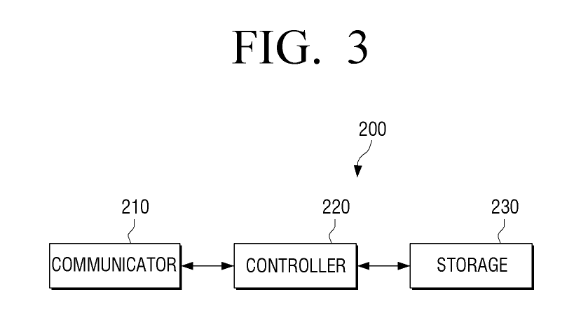

FIG. 3 is a block diagram illustrating the configuration of a server device according to an exemplary embodiment. According to FIG. 3, the server device 200 includes the communicator 210, the controller 220, and the storage 230.

The communicator 210 is an element to perform communication with various display devices. The communicator 210 can perform communication with the display device 100 according to various communication methods such as Wi-Fi, ZigBee, Bluetooth, 3G, 4G, Local Area Network, etc. Accordingly, the communicator 210, when the display device 100 accesses the communicator, can transmit web page data of the server device 200 concerning the display device 100. In addition, the communicator 210 can receive user information from the display device 100. User information is various personal information such as a user name, a birth date, an e-mail address, ID, a password, a photo, a hobby, a specialty, a job, an anniversary, a religion, a preferred content, a preferred channel, etc.

The storage 230 is an element to store user information received through the communicator 210.

The controller 220, when user information is received through the communicator 210, can assign accounts on corresponding users, store user information by assigned accounts, and register users.

In addition, the controller 220 can select an event winner based on user information stored in the storage 230. The event winner can be selected based on various methods according to exemplary embodiments.

For example, the controller 220 can randomly draw a user who has an anniversary among pre-registered users, and select the user as an event winner. Such draw can be done as of the current date, but also can be performed before. For example, if the current date is September 3, the controller 220, before a preset due date (e.g., before 7 days), can extract users whose anniversary is September 3, randomly draw for users, and determine an event winner.

As another example, the controller 220 can calculate points according to a use state of pre-registered users and select an event winner based on the points. The use state may include at least one of the usage history of the display device, the usage history of a service provided by the server device, the usage history of a social network service (SNS) using the display device, log-in numbers on the display device, and log-in numbers on the server device.

In this case, the controller 220 can give high points to a user who watches the display device a lot, a user who uses various services by accessing the server device a lot, a user who frequently uses an SNS service, or a user who frequently conducts log-in to the display device 100 or the server device 200. As described above, if the use state can be divided into various items, the controller 220 can calculate points by assigning value-added weight on each item.

If the points are calculated as shown above, the controller 220 can select users in a pre-determined number in proportion to a calculated point amount as event winners. For example, if there are user 1 to user 10 in an order of high points, and an event winner number is set to 3, the server device 200 selects user 1, 2, and 3 as event winners. Accordingly, the more a user uses the display device 100 or the server device 200, the higher chance of event winning for the user. Therefore, this can motivate users to use the display device 100 or the server device 200 more frequently.

According to still another exemplary embodiment, the controller 220 can select an event winner from among users with lower points. In other words, in the above example, users 10, 9, and 8 can be selected as event winners. In this case, a user who does not frequently use the display device 100 or the server device 200 can be motivated to use them more frequently.

The controller 220, if an event winner is selected, can transmit a multimedia content exclusively created for the event winner to the display device which the event winner uses. The multimedia content can be stored in the storage 230 ahead of the very event date or before the date. A multimedia content can be at least one of a visual message including a photo of an event winner, a video message calling a name of an event winner, a voice message, or a text. In case of a video message or a visual message, it can be a message directly filmed by a celebrity. For example, if there is a celebrity who is an advertisement model of the display device 100, or an official model of a manufacturer of the display device, a manager of the server device 200 can separately create a multimedia content by asking the celebrity. The controller 220 can receive a separately-created multimedia content through the communicator 210 or other input ports, store them in the storage 230, and can provide the stored multimedia content to an event winner when the corresponding event happens. Alternatively, the controller 220 can create and store a multimedia content by itself.

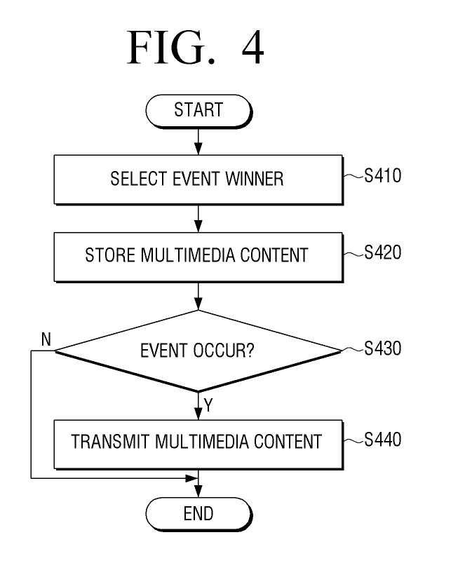

FIG. 4 is a flow chart to explain a method for providing a service of a server device in FIG. 3. According to FIG. 4, the server device 200, when an event winner is selected (S410), creates and stores a multimedia content corresponding to the event winner (S420).

In this status, when an event corresponding to the event winner occurs (S430), the multimedia content can be transmitted to the display device which the event winner uses (S440). For example, when the event winner wins a birthday event, if the birthday of the winner nears, a multimedia content containing a congratulatory message is provided to the winner. Accordingly, a user can receive a congratulatory message which the user has never expected. Therefore, the user satisfaction can be maximized.

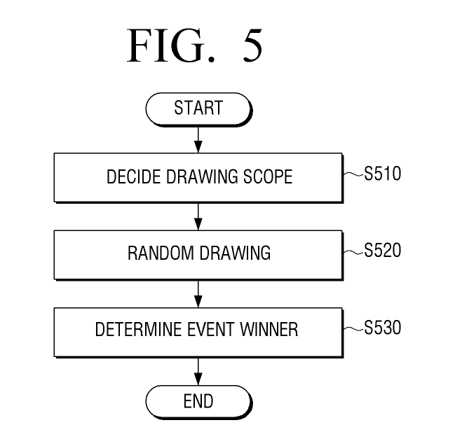

FIG. 5 is an example of a method for selecting an event winner. FIG. 5 illustrates a case of random drawing to select an event winner.

According to FIG. 5, the controller 220 of the server device 200 can check a registered user and decide a drawing scope (S510). In other words, the controller 220 can target entire registered users for every event drawing, but also can select a user scope first and then perform drawing users within the selected scope. For example, the controller 220, whenever a certain number (e.g., 1000 users) of users are registered, can perform a drawing which can target these users. Alternatively, the controller 220, by dividing users based on a certain time (e.g., 1 year) unit, can perform drawings which targets users registered in each time unit.

The drawing can be done in a random manner (S520). The controller 220 sorts registered users in accordance with a registered order and create a random value.

The controller 220, when a random value is created, determines a user of an order corresponding to the random value as an event winner (S530).

Such drawing of an event winner can be done in a monthly basis or an annual basis. In addition, the server device 200, for irregularly-occurred events such as an election, can perform a drawings. In other words, the server device 200 can provide a winner of an election event with a multimedia content which encourages participation in an election.

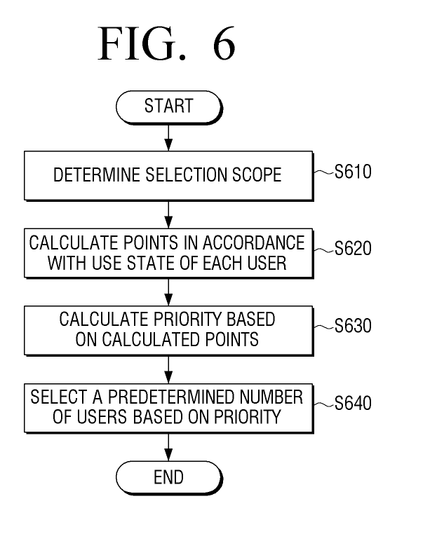

FIG. 6 illustrates another example of selecting an event winner. According to FIG. 6, the controller 220 of the server device 200 can check a registered user and decide a scope of selection (S610). In other words, as illustrated in FIG. 5, the controller 220 can select a user among all the registered users. However, in some cases, the controller 220 can divide a scope of selection in a time unit or a headcount unit, and select an event winner.

For example, if it is set that a user is selected in an annual basis, the controller 220 can select an event winner in 2011 as to users registered in 2010, and select an event winner in 2012 as to users registered in 2011.

The controller 220, when a selection scope is determined, calculates a point according to a use state of the users within the selection scope (S620). As described above, a use state can be divided into various items such as the usage history of the display device, the usage history of a service provided by the server device, the usage history of a social network service (SNS) by using the display device, log-in numbers on the display device, and log-in numbers on the server device, etc. Usage history of a display can be counted with time to watch the display device or watching frequency, and usage history of a service provided by the server device can be counted with time of using an installed application or frequency of using the application. Other items can be counted by using time or frequency. For example, per one time use or using by one hour, one point can be accumulated.

The controller 220, when a point is calculated, can calculate priority of users based on the calculated point (S630). For example, when there are user 1, user 2, and user 3, if their points are 150, 100, and 300, respectively, priority can be calculated in an order of user 3, user 1, and user 2.

The controller 220 can select users in a predetermined number according to priority, and decide them as event winners (S640). For example, if only one event winner should be selected in the above example, user 3 can be decided as an event winner.

According to still another exemplary embodiment, a user can be selected as an event winner in an order of lower priority. According to such an exemplary embodiment, user 2 can be determined as an event winner. Accordingly, a user who does not frequently use the display device 100 or the server device 200 can be motivated to use them more frequently.

In addition to the above, an event can be selected in various methods.

For example, the controller 220 can select all the users having the same registered anniversary as event winners. Alternatively, the controller 220, from among the users having the same registered anniversary, can select a predetermined number of users as event winners, according to an order of using the display device or an order of log-in the server device. Alternatively, the controller 220, from among the registered users, can select a user arbitrarily selected by a user of the server device 200 as an event winner. Alternatively, the controller 220 can select a user who has a large number of recommendations, from among the registered users, as an event winner. In addition, according to the features of an event, type of the display device, or the characteristics of a multimedia content, a method to select an event winner can be embodied in various manners. Moreover, the controller 220 can select all the purchasers of the display device 100 as event winners.

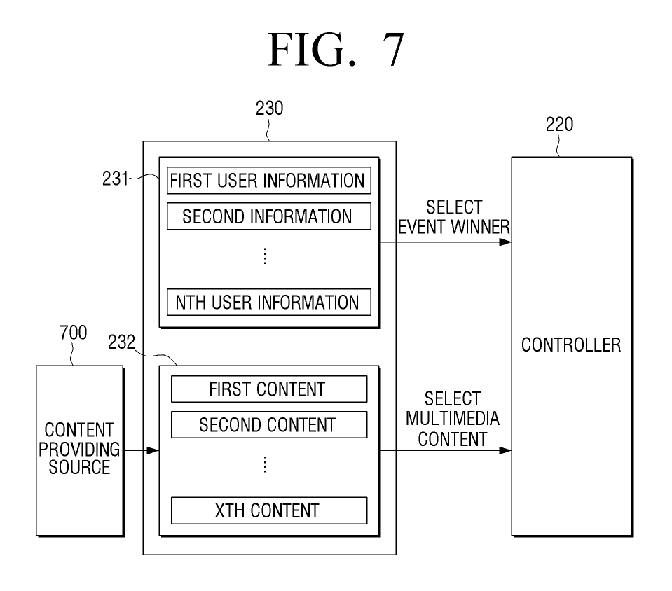

FIG. 7 is a view to explain a data structure stored in a storage of a server device. According to FIG. 7, in the storage 230 of the server device 200, a plurality of database 231, 232 can be stored. The first database 231 stores registered user information. The controller 220, when user information is received from the communicator 210, separates a user name, anniversary, etc. from the user information and aligns the information on the first database 231. The controller 220, based on the first database 231, can select at least one event winner.

A second database 232 stored in the storage 230 includes a multimedia content. The controller 220, when an event winner is selected, can deliver a name of the event winner or other information as the content providing source 700 via on-line or off-line. The content providing source 700, according to a contract with an operator of the server device 200, can generate a multimedia content and provide it to the server device 200. This multimedia content can be delivered via on-line through internet or other network, or delivered to the server device 200 as recorded in a USB memory or other storage media.

The controller 220 registers a provided multimedia content in the second database 232. In order to generate a multimedia content which is exclusive to an event winner as a type of a video, time for preparation is required, and thus the controller 220 can send a request to the content providing source 700 before the event date to prepare a multimedia content. Accordingly, the controller 220 registers the prepared multimedia content to the second database 232 and manages the content.

FIG. 7 illustrates a state where a plurality of contents are registered in the second database 232, but if an event winner is one person, one multimedia content can be registered.

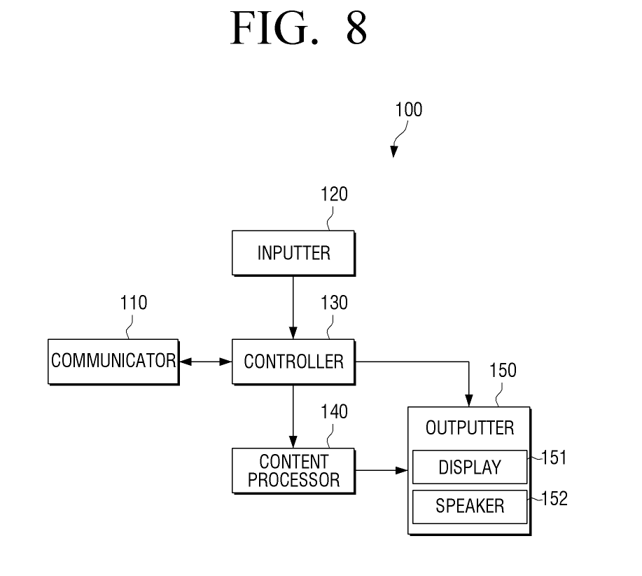

FIG. 8 is a block diagram illustrating the configuration of a display device according to an exemplary embodiment. According to FIG. 8, the display device 100 includes the communicator 110, the inputter 120, the controller 130, the content processor 140, and outputter 150.

The communicator 110 is an element to perform communication with various external devices including the server device 200. The communicator 110, as described above, can connect communication based on various communication methods and transceiver a signal.

The inputter 120 is an element to receive various commands and information according to a user manipulation. The inputter 120 can be embodied as a button mounted in a main body of the display device 100, and a remote controller signal receiving unit which receives a control signal transmitted from a remote control apparatus to control the display device 100. Alternatively, in the case of the display device 100 in a touch screen type, the inputter 120 is composed of a touch sensor disposed at a lower side of the display 151, and can receive various commands or information according to a user touch manipulation.

The controller 130 is an element to control overall operations of the display device 100. The controller 130, when turn-on command on the display device 100 is input, boots the display device 100 and activates each element by supplying power.

In addition, the controller 130 can display a main control screen on the display 151. In the main control screen, a menu to connect communication with the server device 200 can be included. When the corresponding menu is selected, the controller 130 can control the communicator 110 and access the server device 200.

In case of the initial access to the server device 200, the controller 130 can display a user registration screen to register a user account on the display 151. A user, by using the inputter 120, can input various user information on a user registration screen. The controller 130 can transmit the input user information to the server device 200 through the communicator 110 to perform user registration.

In the server device 200, based on user information provided in this method, an event winner can be selected.

When a user of the display device of FIG. 8 is selected as an event winner, the communicator 110 can receive a multimedia content transmitted from the server device 200.

The content processor 140 is an element to reproduce the received multimedia content. In particular, when a multimedia content is a video content, the content processor 140 de-multiplexes the received multimedia content and extracts a video data, an audio data, and a general data, etc. In addition, by performing decoding of each extracted data, a decoded video frame and an audio signal are provided to the outputter 150.

The outputter 150 is an element to output a multimedia content reproduced in the content processor 140. The outputter 150 may include the display 151 and the speaker 152, etc.

The display 151 displays a video frame provided by the content processor 140. In addition, the speaker 152 outputs an audio signal provided by the content processor 140.

When a multimedia content is not a video content, no audio signal can be outputted from the speaker 152.

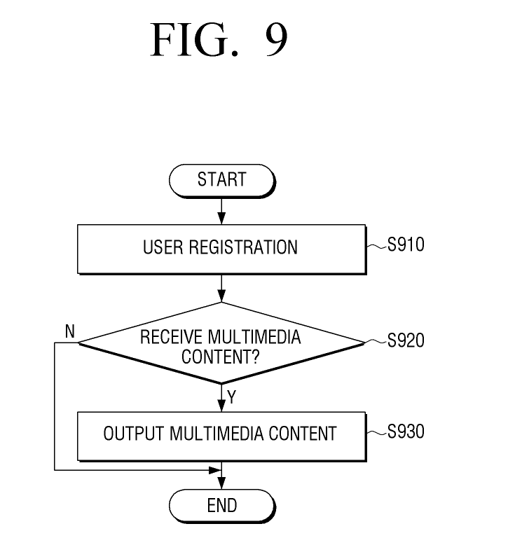

FIG. 9 is a flow chart to explain a method for providing a service of a display device of FIG. 8. According to FIG. 9, the display device 100 can perform user registration by receiving user information from a user and transmitting/registering the information to a server device (S910).

After user registration is completed, when a content is received from the server device 200 (S920), the display device 100 reproduces and outputs the multimedia content (S930). The multimedia content may be a content exclusively generated for a user of the display device 100.

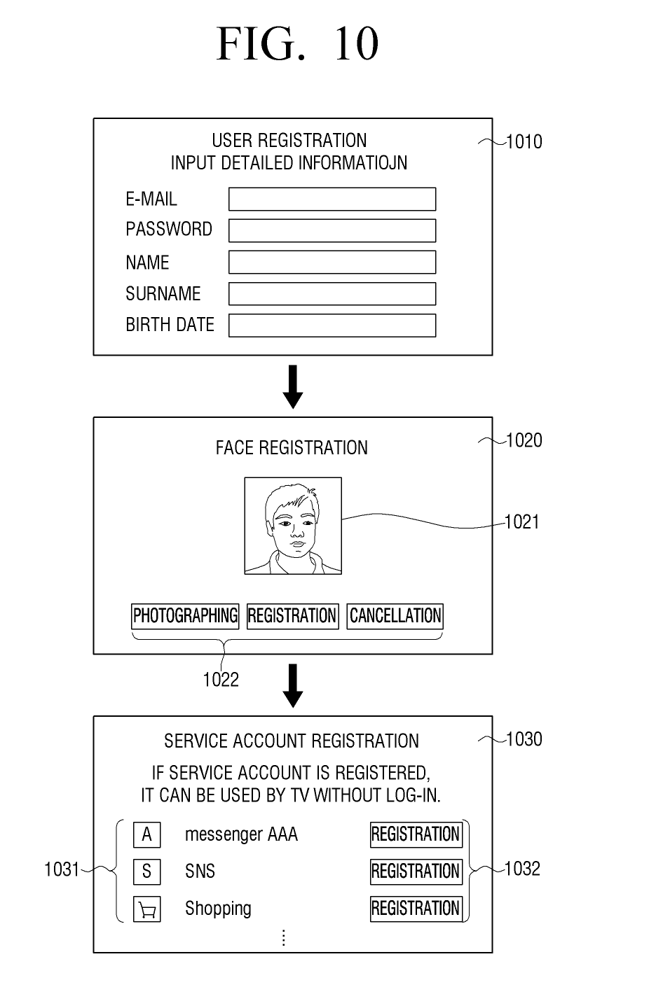

FIG. 10 is a view to explain an example of a user registration process. As described above, in the display device 100, a main control screen can be displayed. In the main control screen, various menus including a user registration menu can be displayed. When a user selects a user registration menu, the display device 100 displays a first screen 1010 where detailed information on a user can be input. In the first screen 1010, an input area in which various personal information such as an e-mail, a password, a name, a surname, and birthday, etc., can be input is displayed.

When entire personal information is input on the first screen 1010, the display device 100 displays a second screen 1020 where a user face can be registered. On the second screen 1020, a live view 1021 filmed by a camera (not illustrated) in the display device 100, and a menu 1022 such as photographing, photograph registration, cancellation, etc., can be displayed.

When a photograph is registered on the second screen 1020, the display device 100 can display a third screen 1030 where a service to be registered in the server device 200 can be selected. In the third screen 1030, information on a service that can be linked to an acquaintance or an external program such as a messenger program, a social network service (SNS) program, a shopping program 1031, and a menu which can register a service thereof 1032 can be displayed. When a service is registered on the third screen 1030, a user, when performing log-in on the display device 100, can use a corresponding service through the display device 100 without performing log-in by services. In other words, an icon corresponding to each service can be displayed on one side of a screen, and when a user selects the icon, the display device 100 can provide the corresponding service immediately.

Therefore, through a screen on several pages, a user can input personal information, i.e., user information. The display device 100 can transmit at least one of the input user information to the server device 200, and perform user registration. E-mail and a password can be used as identification information with which a user can perform a log-in to the server device 200.

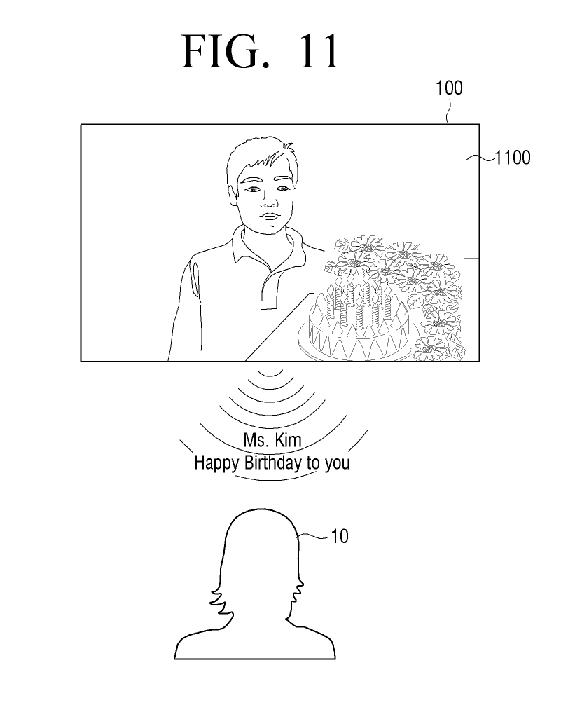

FIGS. 11-14 are views to explain various examples of a multimedia content displayed in the display device 100.

First of all, FIG. 11 indicates a case of reproducing a content made as a video. The display device 100, if it is turned on for the first time on the event date, or it is determined that the event winner 10 is watching the display device 100, outputs the multimedia content 1100 provided by the server device 200. The display device 100 can check the current viewers of the display device 100 by photographing a front area of the display 110 and analyzing a photographed image. Accordingly, if there is a user who is coincident with a photo within pre-registered user information, it can be determined that the event winner 10 is watching.

A multimedia content can be a video content in which a celebrity directly gives a user name and a congratulatory message with his or her own voice.

As described above, a celebrity can be arbitrarily selected by an operator of the server device 200, or an entertainer who is an advertisement model of the display device 100 can be selected. In this case, an item regarding generating a multimedia content can be included in an advertisement contract. Alternatively, a celebrity can be selected based on user information of the event winner. For example, if it is determined that the event winner belongs to a fan club of a certain entertainer, or has watched a content containing the certain entertainer a lot, a multimedia content can be recorded by asking the entertainer. In a case when the event winner is a foreigner, a multimedia content can be recorded in the foreigner's own language. As such, a multimedia content can be exclusively generated for a user. Thus, the multimedia content can greatly improve user satisfaction. As to a video content as illustrated in FIG. 11, a subtitle or a graphic image including a user name can be displayed together.

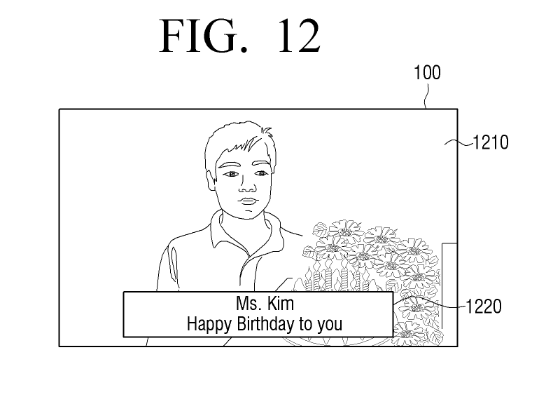

FIG. 12 is a view illustrating another example of a multimedia content. According to FIG. 12, a multimedia content can be generated by combining a photo 1210 and a text 1220. The photo 1210 can be various images such as the event winner photo, a photo of other celebrities, a photo of an acquaintance of the event winner, a photo of famous picture, a capture screen of a content the event winner likes, etc. The text 1220 can include a name of the event winner and a congratulatory message. The controller 220 of the server device 200 can generate a text including a user name and a congratulatory message, and generate a multimedia content by composing the text with a stored photo. In this case, background music can be included in the multimedia content.

Meanwhile, in FIGS. 11 and 12, it has been illustrated that a multimedia content is displayed on entire screen, but the controller 130 can display the multimedia content with picture in picture (PIP) or picture by picture (PBP) type. Accordingly, a user can watch a multimedia content along with a screen which the user was watching.

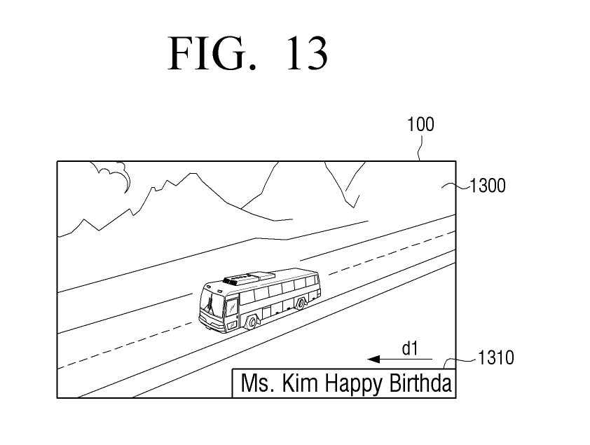

FIG. 13 is a view illustrating still another example of a multimedia content. According to FIG. 13, a multimedia content can be embodied as a simple text message. The display device 100 can display the text message 1310 within the content screen 1300 which the user is watching now. In this case, if length of the text message 1310 is long, it can be displayed in a subtitle which is slid in one direction (d1) within a screen. In FIG. 13, it has been illustrated that the text message is displayed on a side of a lower part of the screen, but exemplary embodiments are not limited. In other words, a text message can be displayed on an edge of top, low, left and right directions of a screen or on a center of the screen 10.

In the above-described exemplary embodiments, it has been explained that, when the event winner turns on or watches the display device 100, the multimedia content is output without giving a separate notice to the event winner. However, exemplary embodiments are not limited to this. In other words, after notifying that a multimedia content is received, when the event winner inputs a check command on the received multimedia content, the content can then be output.

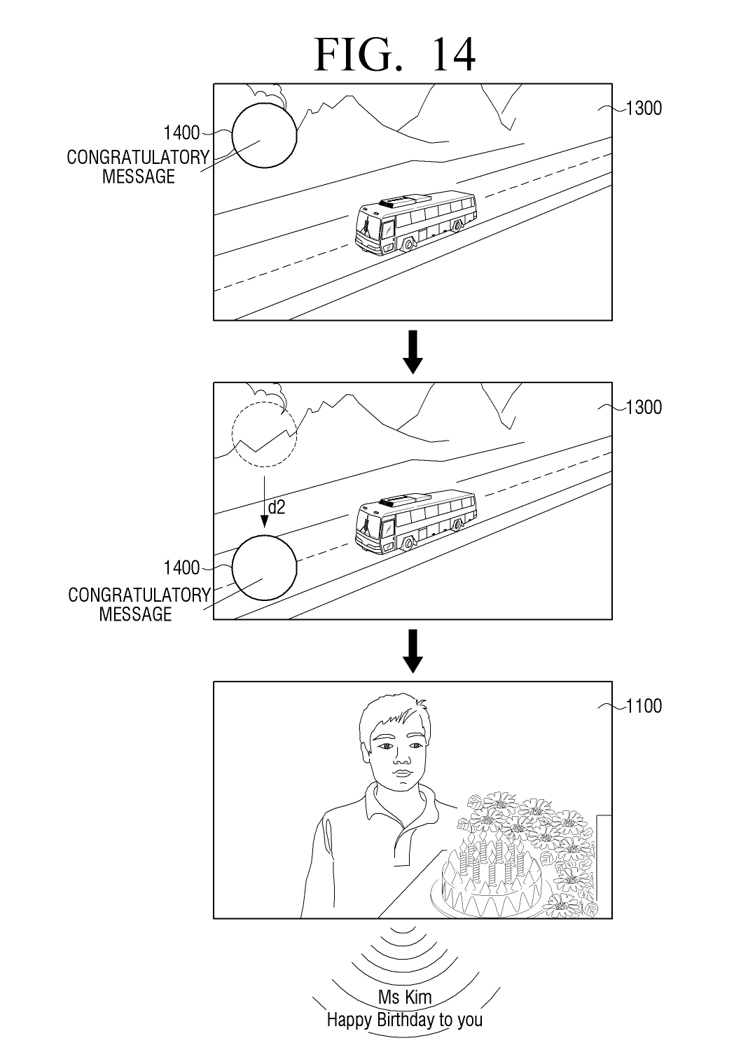

FIG. 14 is a view to explain another method to output a multimedia content. According to FIG. 14, when a multimedia content is received, the controller 130 displays a Graphic User Interface (GUI) object 1400 within a screen of the display 151 that a multimedia content is received.

When the display device 100 includes a touch screen display, a user can touch the GUI object 1400, and drag or flick it in one direction (d2). The controller 130, when the first touch coordinate value which is input through a touch sensor mounted in a lower side of the display 151 is the same as the coordinate value of the GUI object 1400, and when a moving trace under a touch state is the same as a preset direction (e.g., d2), determines that a command to output a multimedia content is input. Accordingly, after moving a display location of the GUI object 1400 according to a moving trace, when a touch is released, the multimedia content 1100 is output through the display 151 and the speaker 152.

In case that it is not a touch screen display, the controller 130, while the GUI object 1400 is displayed, when a button mounted on a remote control device or a button mounted on a main body of the display device 100 is selected, can determine that a multimedia content output command is input. Accordingly, reproduction can be performed right away.

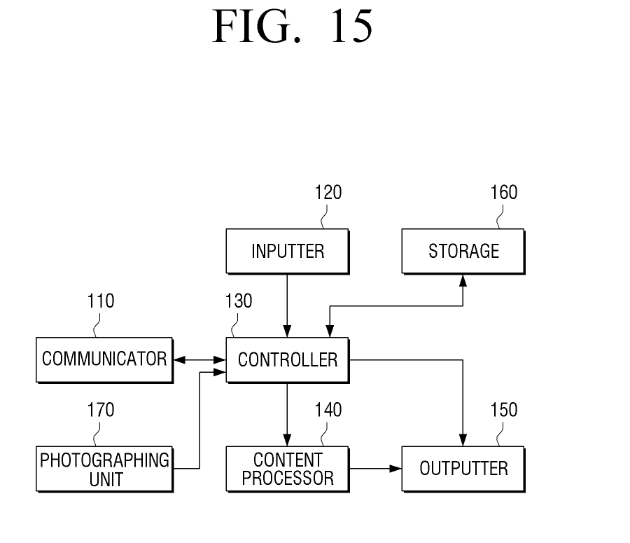

FIG. 15 is a block diagram illustrating the configuration of a display device according to still another exemplary embodiment. According to FIG. 15, the display device 100 includes the communicator 110, the inputter 120, the controller 130, the content processor 140, the outputter 150, the storage 160, and the photographing unit 170.

The communicator 110, as described above, performs operations such as performing communication with the server device 200 and transmitting user information, and receiving a multimedia content, etc. The inputter 120 is an element to receive user information, and the content processor 140 is an element to process the received multimedia content through the communicator 110. The outputter 150 is an element to output the processed multimedia content through the display 151 or the speaker 152. As this element has been described in detail in another exemplary embodiment, further explanation will be omitted.

The photographing unit 170 is an element to photograph a user. The controller 130, when the display device 100 is turned on, activates the photographing unit 170 and photographs a user. The controller 130 analyzes a photographed image and determines which user is watching. The photographing unit 170 may include a circuit, a hardware module, or a processor.

In particular, the controller 130 divides a photographed image into a plurality of pixel blocks. Each pixel block can be composed of a predetermined number of pixels. The controller 130 calculates a representative value of each pixel block. This representative value can be set in a diverse manner including an average pixel value of pixels within a corresponding block, a maximum pixel value, and a total add-up value, etc. The controller 130 compares a representative value of a pixel with neighboring blocks. As a result, if blocks having the same or similar scope of representative value of a pixel are extracted successively, it is recognized that the corresponding blocks form one object. The controller 130, based on the number of blocks which form an object, a type of block arrangement, and a pixel value, etc., can determine whether or not the corresponding object is a part of the face. When the part of the face is extracted, the controller 130 compares it with an analysis result on a photo within user information which a user already registered, and calculates a degree of similarity. Accordingly, the controller 130, even if many users use the display device 100, can detect whether or not there is an event winner among these users and notify the server device 200.

As a still another example, the controller 130, when a user logs in, can determine which user is using the display device 100, based on log-in information. In other words, when a user A performs log-in, the controller 130 may notify of the server device 200 that the user A is using the display device 100. The server device 200, when a user A is an event winner, can transmit a multimedia content.

The storage 160 is an element to store a multimedia content received through the communicator 110. The controller 130, when a multimedia content is received, can display a user interface (UI) for asking whether to store the corresponding content (this may occur even before or after outputting, or in the midst of outputting the content on the display 151). Accordingly, when a user inputs a storage command, a multimedia content can be stored in the storage 160.

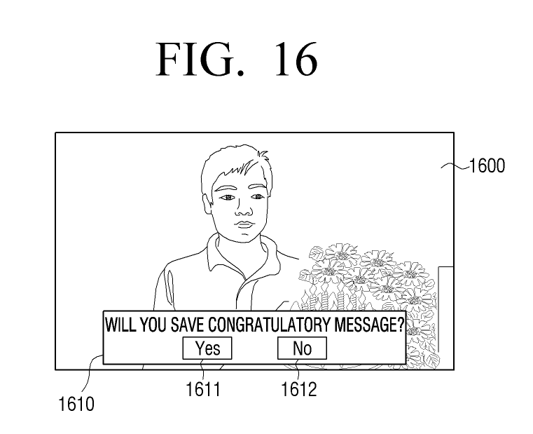

FIG. 16 illustrates an example of an output screen of a multimedia content and a UI for storing the content. According to FIG. 16, a UI 1610 asking whether to store a multimedia content is displayed within the output screen 1600 of a multimedia content. Within the UI 1610, a menu 1611, 1612 selectable by a user is included. The controller 130, when a user selects the menu 1611 to be stored, stores the corresponding multimedia content in the storage 160.

The controller 130 can share a multimedia content provided from the server device 200 with others.

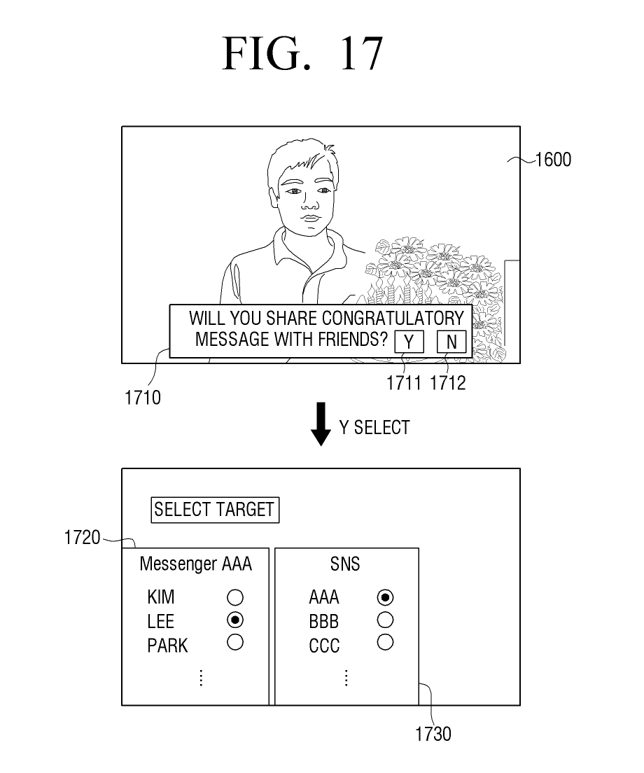

FIG. 17 is a view illustrating an example of a method to share a multimedia content. According to FIG. 17, the controller 130 can display a UI 1710 asking whether to share the corresponding content with others within the output screen 1600 of a multimedia content. Within the UI 1710, a guide menu and a menu 1711, 1712 selectable by a user can be displayed.

Accordingly, when a user selects a menu 1711 to be shared, the controller 130 displays UIs 1720, 1730 to select a target of sharing. In each UI, information on people relevant to the event winner is displayed.

According to FIG. 17, in the messenger UI 1720, a selection area where a user can select information on acquaintances registered in the messenger program and the acquaintances is displayed. In addition, in a SNS UI 1730, a selection area where a user can select information on acquaintances registered in the SNS server and the acquaintances is displayed. When a user selects a target on the UIs 1720, 1730, the controller 130 can transmit a multimedia content to a user terminal device corresponding to the corresponding target or the display device.

In FIG. 17, it has been illustrated that a UI which can select a target is provided by each program, but an event winner can select a program to select a target.

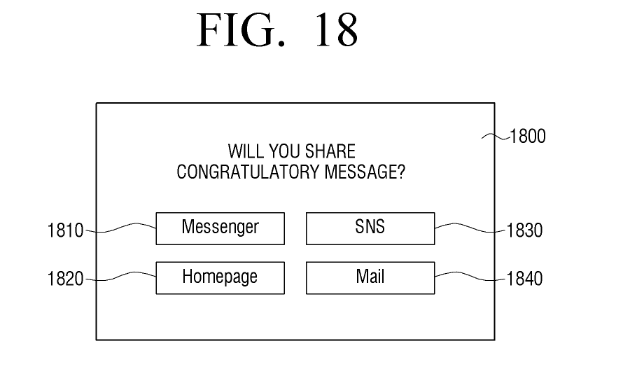

FIG. 18 is a view illustrating another example of a method to share a multimedia content. According to FIG. 18, the controller 130, when a multimedia content is received, can display a UI 1800 to ask whether or not to share a corresponding content before, after, or during outputting. In the UI 1800, a menu 1810 through 1840 which corresponds to various services registered by a user can be displayed. FIG. 18 illustrates a state where a menu 1810 through 1840 such as a messenger program, an SNS, a website, and a mail, etc., are displayed. When a user selects one of these menus, the controller 130 can display personal information stored in a program corresponding to the menu as a list type and make a user select personal information.

The controller 130 can display various types of UIs on the display 151 by using a GPU (Graphic Processing Unit). The GPU calculates attribute values such as a coordinate value where each UI will be displayed, shape, size, color, etc., according to a layout of a screen. The GPU, when location where a UI will be displayed is decided in accordance with calculation results, can render the UI on the corresponding location.

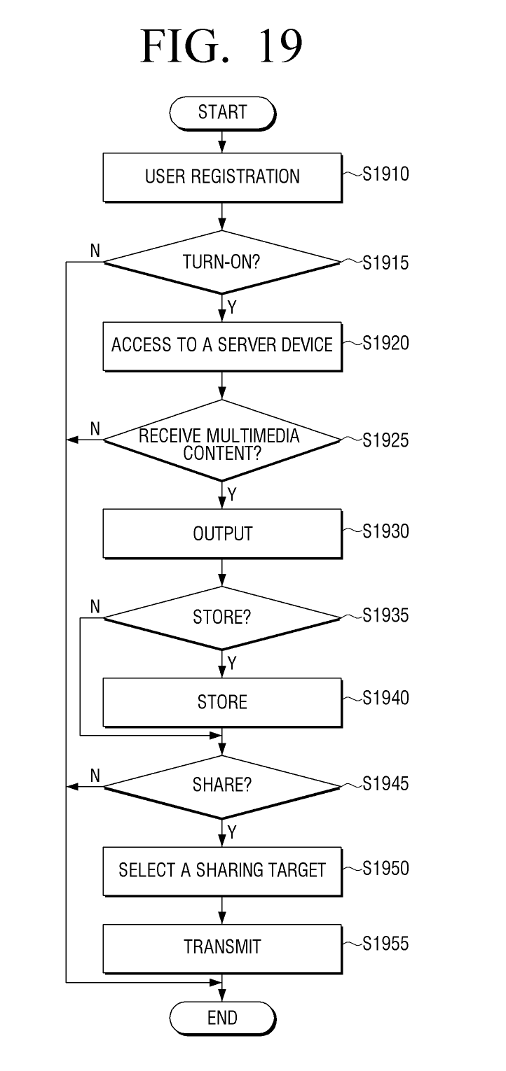

FIG. 19 is a flow chart to explain a method for providing a service of a display device according to another exemplary embodiment. According to FIG. 19, the display device 100, when user registration is performed (S1910), transmits user information to the server device 200.

Whenever the display device 100 is turned on (S1915), the display device accesses the server device 200 (S1920) and performs communication. If log-in is performed by users, the display device 100 can transmit log-in information to the server device 200 after log-in is completed, and notify the user which is using the device.

If a user of the display device 100 is selected as an event winner, when the display device 100 is turned on the event date for the first time, or use of the event winner on the event date is detected, the display device 100 can receive a multimedia content transmitted from the server device 200 (S1925).

The display device 100 can output the received multimedia content (S1930).

In this state, when a user inputs a storing command (S1935), the display device 100 stores a multimedia content (S1940). In this case, the content can be stored in the storage 160 which is embedded in the display device 100, but exemplary embodiments are not limited to this case. For example, the display device 100 may ask the server device 200 to store a multimedia content at a storage area allocated to the corresponding user.

When a user inputs a sharing command (S1945), and selects a target for sharing (S1950), the display device 100 can transmit a multimedia content for a selected target of sharing (S1955). When there is no selection of a target for sharing, the display device 100 or the server device 200 can transmit a multimedia content to entire users registered as acquaintances of the corresponding user. Accordingly, an event winner can share a message which the user received as a gift with acquaintances and enhance satisfaction.

In the above-described exemplary embodiments, it has been described that the server device 200 selects an event winner based on user information, but exemplary embodiments are not necessarily limited. For example, an event winner can be selected through other user applications or recommendations.

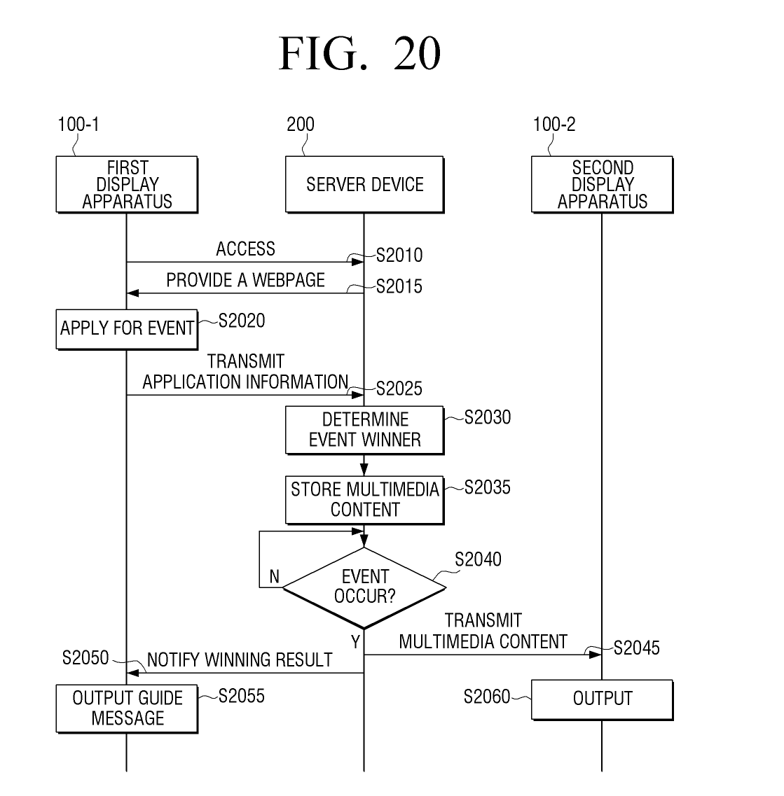

FIG. 20 is a timing diagram to explain the operations of a service providing system according to still another exemplary embodiment.

According to FIG. 20, a service providing system includes the server device 200 and the display device 100-1, 100-2. For convenience, only two display devices are illustrated, but in the server device 200, a larger number of display devices can be connected.

When the first user of the first display device 100-1 accesses the server device 200, the server device 200 provides web page data regarding the first display device 100-1. The first display device 100-1, by using web page data, displays a web page of the server device 200. Various menus can be displayed on a web page. Among the menus, a menu to recommend a certain user and apply for an event can be included. When the first user recommends the second user of the second display device 100-2 and applies for an event (S2020), the application information is transmitted to the server device 200 (S2025).

The server device 200 can receive event application for a certain period of time. Thereafter, the server device 200 can select an event winner from among recommended targets (S2030). In this case, as described above, a random drawing can be used for selection, or other various criteria such as a larger recommendation can be used.

When an event winner is selected, the server device 200 stores a multimedia content which is exclusively generated for the event winner (S2035). As a method for generating a multimedia content has been explained in detailed above, further explanation will be omitted.

The server device 200, while an event data nears in this state and an event happens (S2040), transmits a multimedia content to the second display device 100-2 which the second user who is an event winner uses (S2045).

The second display device 100-2 outputs a received multimedia content (S2060). Meanwhile, the server device 200 can separately notice the first user who applies for an event of news that the second user wins an event (S2050). In the first display device 100, a message notifying that a user wins an event can be output (S2055).

As shown above, the server device 200 can improve user satisfaction by providing a user with a multimedia content in various methods.

A method for proving various services as described above can be embodied as a program code and provided while being stored in a non-transitory readable medium. In a server device or display device where such non-transitory readable medium is mounted, a program code can be executed, and a method for providing a service according to the above-described various exemplary embodiments can be implemented.

A non-transitory computer-readable medium indicates media which semi-permanently stores data and is readable with an apparatus, not a media which stores data for short time such as register, cache, memory, etc. In particular, the above-described various applications or programs may be stored and provided in a non-transitory computer-readable medium such as CD, DVD, hard disk, Blue-ray disk, USB, memory card, ROM.

The foregoing embodiments and advantages are merely exemplary and are not to be construed as limiting the exemplary embodiments. The present teaching can be readily applied to other types of devices. Also, the description of the exemplary embodiments is intended to be illustrative, and not to limit the range of the claims. Many alternatives, modifications, and variations will be apparent to those skilled in the art.

What is claimed is:

1. A method for providing a service of a server device, the method comprising:
selecting an event winner from a plurality of users registered in the server device;
storing a multimedia content which is exclusively generated for the event winner; and
transmitting the multimedia content to a display device which the event winner uses in response to a predetermined event occurring.

2. The method as claimed in claim 1, further comprising:
receiving and registering user information from at least one display device which is connected to the server device,
wherein the event winner is selected based on the user information.

3. The method as claimed in claim 1, wherein the selecting the event winner comprises:
randomly drawing a user who has a birthday or an anniversary from the users registered in the server device, and
selecting the user as the event winner.

4. The method as claimed in claim 1, wherein the selecting the event winner comprises:
calculating a point according to a use state of the users registered in the server device; and
selecting the event winner based on the calculated point.

5. The method as claimed in claim 4, wherein the use state comprises:
at least one of a usage history of a display device, a usage history of a service provided by the server device, a usage history of a social network service (SNS) which uses the display device, and a plurality of log-in numbers on the service device.

6. The method as claimed in claim 1, wherein the multimedia content comprises:
at least one of a visual message which includes a photo of the event winner, a video message which calls a name of the event winner, a voice message, and a text.

7. A method for providing a service of a display device, the method comprising:
transmitting and registering user information to a server device;
receiving a multimedia content from the server device; and
reproducing and outputting the multimedia content,
wherein the multimedia content is a content which is exclusively generated for the user of the display device.

8. The method as claimed in claim 7, further comprising:
transmitting the multimedia content to at least one other display device in response to a sharing command being input on the multimedia content.

9. The method as claimed in claim 7, wherein the multimedia content comprises:
at least one of a visual message which includes a photo of the user, a video message which calls a name of the user, a voice message, and a text.

10. A server device, comprising:
a communicator which is configured to receive user information from a display device;
a storage which is configured to store the user information; and
a controller configured to transmit a multimedia content which is exclusively generated for an event winner to a display device which the event winner uses in response to the event winner being selected using the user information stored in the storage.

11. The device as claimed in claim 10, wherein the controller is further configured to extract information on a birthday or an anniversary from the user information stored in the storage, randomly draw a user who has the birthday or the anniversary on a current date, and select the user as the event winner.

12. The device as claimed in claim 10, wherein the controller is further configured to calculate a point according to a use state of a plurality of users whose corresponding user information is stored, and select the event winner based on the calculated point.

13. The device as claimed in claim 12, wherein the use state comprises:
at least one of a usage history of a display device, a usage history of a service provided by the server device, a usage history of an social network service (SNS) which uses the display device, and a plurality of log-in numbers on the service device.

14. The device as claimed in claim 10, wherein the multimedia content comprises:
at least one of a visual message which includes a photo of the event winner, a video message which calls a name of the event winner, a voice message, and a text.

15. A display device, comprising:
a communicator which is configured to perform communication with a server device;
an inputter which is configured to receive user information;
a controller which is configured to transmit the user information to the server device through the communicator and perform user registration;
a content processor configured to reproduce a multimedia content in response to the multimedia content being transmitted from the server device; and
an outputter which is configured to output the reproduced multimedia content.

16. The device as claimed in claim 15, wherein the controller is further configured to transmit the multimedia content to at least one another terminal device and share the multimedia content in response to a sharing command being input on the multimedia content.

17. The device as claimed in claim 15, wherein the controller notifies information of the user log-in to the server device in response to a user log-in being performed on the display device.

18. The device as claimed in claim 15, further comprising:
a photographing device configured to perform photographing,
wherein the controller is configured to detect a user included in an image photographed by the photographing device and notify a detecting result to the server device.

19. The device as claimed in claim 15, wherein the multimedia content comprises at least one of a visual message including the user photo, a video message calling a user name, a voice message, and a text.

20. A method of providing a service of a server device to a plurality of display devices, the method comprising:
receiving an event application from a first display device of the display devices;
selecting an event winner from a plurality of registered users in the server device in response to the event application being received;
storing a multimedia content which is exclusively generated for the event winner;
transmitting the multimedia content to a second display device of the display devices; and
notifying the first display device of the event winner.

21. The method as claimed in claim 20, further comprising:
sending webpage data to the first display device in response to the first display device accessing the server device.

22. The method as claimed in claim 20, wherein the selecting the event winner comprises:
randomly drawing a user who has a birthday or an anniversary from the registered users in the server device; and
selecting the user as the event winner.

23. The method of claim 20, wherein the selecting the event winner comprises:
calculating a point according to a user state of a plurality of users registered in the server device; and
selecting the event winner based on the calculated point.

24. The method of claim 20, wherein the multimedia content comprises at least one of a visual message, a video message, a voice message, and a text.
